(19) United States
(12) Patent Application Publication
(10) Pub. No.: US 2025/0381650 A1
(43) Pub. Date: Dec. 18, 2025

(54) ANTI-SLIP DRIVE TOOL

(71) Applicant: Hong Ann Tool Industries Co., Ltd., Taichung City (TW)

(72) Inventor: Cheng-Wei SU, Taichung City (TW)

(21) Appl. No.: 19/172,990

(22) Filed: Apr. 8, 2025

(30) Foreign Application Priority Data
Jun. 14, 2024 (TW) 113122097

(51) Int. Cl. B25B 15/00; B25B 27/18

(52) U.S. Cl. CPC B25B 15/008; B25B 27/18

(57) ABSTRACT

An anti-slip drive tool is provided, comprising a body portion and a drive portion at one end of the body portion. The drive portion includes a rotational axis, a first peripheral surface along the outer radial periphery relative to the rotational axis, and a first end surface at the end opposite the body portion. The first end surface includes a first edge lying on a reference plane perpendicular to the rotational axis, and a first corner positioned between the reference plane and the body portion. A recessed first anti-slip groove is formed in the first peripheral surface, extending from the first end surface toward the body portion. The anti-slip groove enhances the engagement between the drive tool and fastener, reducing slippage and wear during use. This tool addresses the shortcomings of conventional drive tools, improving driving efficiency and durability.

### BACKGROUND OF THE INVENTION

The present invention relates to drive tools, and more particularly, to a drive tool with anti-slip functionality.

Conventional drive tools, such as hex wrenches and screwdriver bits, are used to drive fasteners like bolts and screws. Fasteners are typically made from softer materials than the drive tools to reduce costs, which leads to wear during use. Additionally, using tools that do not match the fastener's specifications can accelerate wear, causing stripped threads and rounded drive holes. This wear prevents the tool from effectively engaging the fastener, resulting in slippage and an inability to drive the fastener.

As the drive hole rounds, the tool loses the engagement points needed to transfer torque, worsening with each attempt to turn a damaged fastener. This issue is particularly common when fasteners are frequently removed or exposed to corrosive environments, leading to increased downtime and maintenance costs in industrial applications.

The present invention is, therefore, intended to obviate or at least alleviate the problems encountered in the prior art.

### SUMMARY OF THE INVENTION

The present invention provides an anti-slip drive tool designed to improve the engagement between a drive tool and a fastener, minimizing slippage during driving operations. The drive tool includes a body portion and a drive portion formed at one end of the body portion. The drive portion has a rotational axis and a first peripheral surface along the outer radial periphery relative to the rotational axis. At the end opposite the body portion, the drive portion includes a first end surface that connects to the first peripheral surface.

The first end surface includes a first edge and a first corner. The first edge lies on a reference plane that is perpendicular to the rotational axis. The first corner is located between the reference plane and the body portion. A recessed first anti-slip groove is formed in the first peripheral surface. The first anti-slip groove connects to the first end surface at one end and extends toward the body portion at the other end, enhancing the grip and preventing slippage during use.

This structure allows for improved interaction between the drive tool and the fastener, addressing the drawbacks of conventional tools and ensuring greater efficiency and durability in driving operations.

There has thus been outlined, rather broadly, the more important includes of the invention in order that the detailed description thereof that follows may be better understood, and in order that the present contribution to the art may be better appreciated. There are additional includes of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the concept upon which this disclosure is based may readily be utilized as a basis for designing other structures, methods, and systems for carrying out the several purposes of the invention. It is important, therefore, that the claims be regarded as including such equivalent constructions insofar as they do not deviate from the spirit and scope of the invention.

Furthermore, the purpose of the abstract is to enable the general public, particularly scientists, engineers, and practitioners in the field who may not be familiar with patent or legal terminology, to quickly determine the nature and essence of the technical information through a brief examination. The abstract is not meant to define the invention, which is determined by the claims, nor is it intended to limit the scope of the invention in any manner.

Other objectives, advantages, and new includes of the invention will become apparent from the following detailed description of the invention when considered in conjunction with the accompanied drawings.

### BRIEF DESCRIPTION OF DRAWINGS

FIG. 1 is a perspective view of an anti-slip drive tool according to a first embodiment of the present invention.

FIG. 2 is a side view of the anti-slip drive tool of FIG. 1.

FIG. 3 is a top view of the anti-slip drive tool of FIG. 1.

FIG. 4 is a perspective view of an anti-slip drive tool according to a second embodiment of the present invention.

FIG. 5 is a side view of the anti-slip drive tool of FIG. 4.

FIG. 6 is a top view of the anti-slip drive tool of FIG. 4.

### DETAILED DESCRIPTION OF THE INVENTION

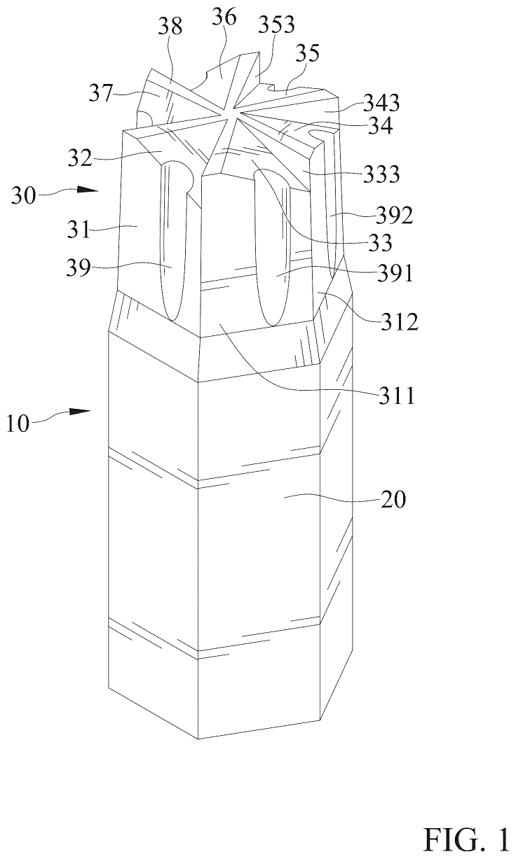

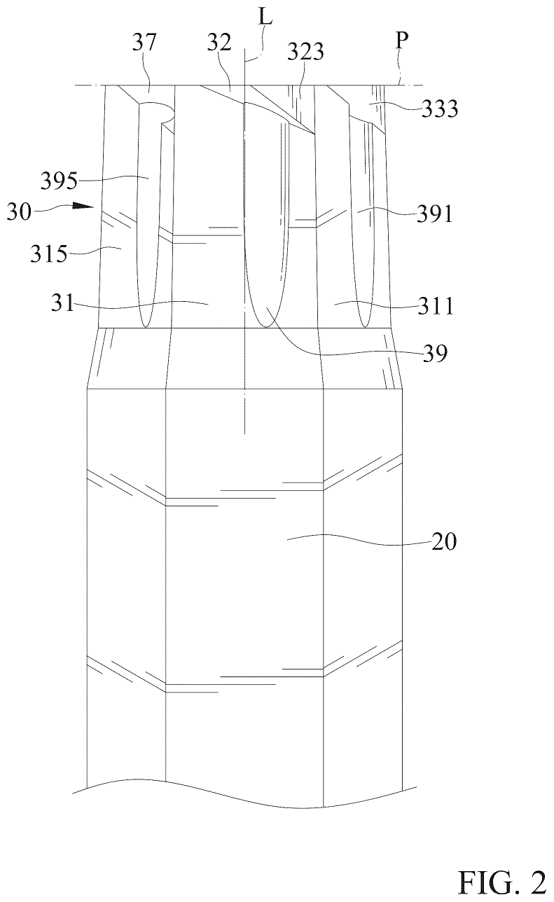

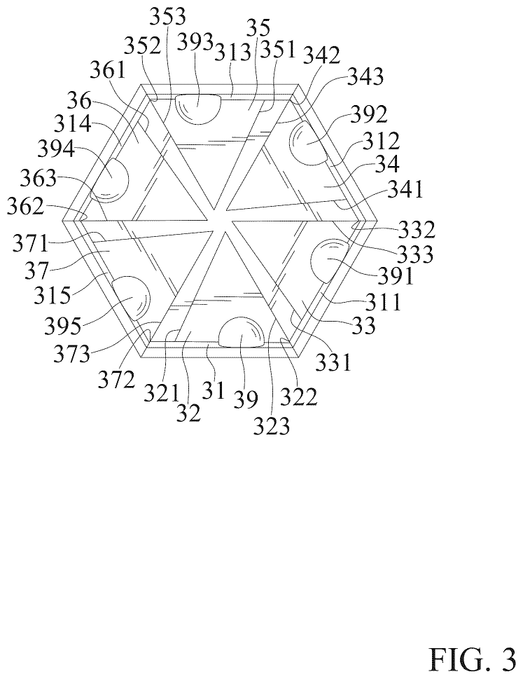

Referring to FIGS. 1-3, an anti-slip drive tool 10 according to a first embodiment of the present invention includes a body portion 20 and a drive portion 30.

The body portion 20 includes a main shaft. The drive portion 30 is formed at one end of the body portion 20. The drive portion 30 has a rotational axis L and a first peripheral surface 31 along its outer radial periphery relative to the rotational axis L. A first end surface 32 is provided at the end of the drive portion 30 opposite to the body portion 20 and connects to the first peripheral surface 31. The first end surface 32 includes a first edge 321 and a first corner 322 not on the first edge 321. The drive portion 30 has a reference plane P at its end opposite to the body portion 20, which is perpendicular to the rotational axis L. The first edge 321 lies on the reference plane P, with one end proximate to the rotational axis L and the opposite end connecting to the first peripheral surface 31. The first corner 322 is positioned between the reference plane P and the body portion 20. The first peripheral surface 31 includes a recessed first anti-slip groove 39, with one end connecting to the first end surface 32 and the other end extending toward the body portion 20.

The end of the first anti-slip groove 39 that connects to the first end surface 32 does not connect to either the first edge 321 or the first corner 322, thereby maximizing engagement while minimizing stress on the fastener.

The distance from the connection point of the first anti-slip groove 39 with the first end surface 32 to the first edge 321 is greater than the distance from the connection point to the first corner 322.

The first end surface 32 connects to a first drive surface 323, which extends parallel to the rotational axis L. The first drive surface 323 connects to the first corner 322 and does not intersect with the rotational axis L. The edge of the first drive surface 323 opposite to the first end surface 32 lies on the reference plane P.

The drive portion 30 includes a second peripheral surface 311 along its outer radial periphery relative to the rotational axis L. A second end surface 33 is provided at the end of the drive portion 30 opposite to the body portion 20 and connects to the second peripheral surface 311. The second peripheral surface 311 is adjacent to the first peripheral surface 31. The second end surface 33 includes a second edge 331 and a second corner 332 not on the second edge 331. The second edge 331 lies on the reference plane P. An end of the second edge 331 proximate to the rotational axis L does not lie on the rotational axis L. Another end of the second edge 331 connects to the second peripheral surface 311. The second corner 332 is positioned between the reference plane P and the body portion 20. The second peripheral surface 311 includes a recessed second anti-slip groove 391, with one end connecting to the second end surface 33 and the other end extending toward the body portion 20.

The distance from the connection point of the second anti-slip groove 391 with the second end surface 33 to the second edge 331 is greater than the distance from the connection point to the second corner 332.

The second end surface 33 connects to a second drive surface 333, which extends parallel to the rotational axis L. The second drive surface 333 connects to the second corner 332 and does not intersect with the rotational axis L. The edge of the second drive surface 333 opposite to the second end surface 33 lies on the reference plane P.

The drive portion 30 includes third through sixth peripheral surfaces 312, 313, 314, and 315 along its outer radial periphery relative to the rotational axis L, and corresponding third through sixth end surfaces 34, 35, 36, and 37 at the end opposite to the body portion 20. The third end surface 34 connects to the third peripheral surface 312, which is adjacent to the second peripheral surface 311 and positioned on the side opposite to the first peripheral surface 31. The third end surface 34 includes a third edge 341 and a third corner 342 not on the third edge 341. The third edge 341 lies on the reference plane P, with one end proximate to the rotational axis L but not lying on the rotational axis L and the opposite end connecting to the third peripheral surface 312. The third corner 342 is positioned between the reference plane P and the body portion 20. The third peripheral surface 312 includes a recessed third anti-slip groove 392, with one end connecting to the third end surface 34 and the other end extending toward the body portion 20.

The distance from the connection point of the third anti-slip groove 392 with the third end surface 34 to the third edge 341 is greater than the distance from the connection point to the third corner 342.

The third end surface 34 connects to a third drive surface 343, which extends parallel to the rotational axis L. The third drive surface 343 connects to the third corner 342 and does not intersect with the rotational axis L. The edge of the third drive surface 343 opposite to the third end surface 34 lies on the reference plane P.

The fourth end surface 35 connects to the fourth peripheral surface 313, which is adjacent to the third peripheral surface 312 and positioned on the side opposite to the second peripheral surface 311. The fourth end surface 35 includes a fourth edge 351 and a fourth corner 352 not on the fourth edge 351. The fourth edge 351 lies on the reference plane P, with one end proximate to the rotational axis L but not lying on the rotational axis L and the opposite end connecting to the fourth peripheral surface 313. The fourth corner 352 is positioned between the reference plane P and the body portion 20. The fourth peripheral surface 313 includes a recessed fourth anti-slip groove 393, with one end connecting to the fourth end surface 35 and the other end extending toward the body portion 20.

The distance from the connection point of the fourth anti-slip groove 393 with the fourth end surface 35 to the fourth edge 351 is greater than the distance from the connection point to the fourth corner 352.

The fourth end surface 35 connects to a fourth drive surface 353, which extends parallel to the rotational axis L. The fourth drive surface 353 connects to the fourth corner 352 and does not intersect with the rotational axis L. The edge of the fourth drive surface 353 opposite to the fourth end surface 35 lies on the reference plane P.

The fifth end surface 36 connects to the fifth peripheral surface 314, which is adjacent to the fourth peripheral surface 313 and positioned on the side opposite to the third peripheral surface 312. The fifth end surface 36 includes a fifth edge 361 and a fifth corner 362 not on the fifth edge 361. The fifth edge 361 lies on the reference plane P, with one end proximate to the rotational axis L but not lying on the rotational axis L and the opposite end connecting to the fifth peripheral surface 314. The fifth corner 362 is positioned between the reference plane P and the body portion 20. The fifth peripheral surface 314 includes a recessed fifth anti-slip groove 394, with one end connecting to the fifth end surface 36 and the other end extending toward the body portion 20.

The distance from the connection point of the fifth anti-slip groove 394 with the fifth end surface 36 to the fifth edge 361 is greater than the distance from the connection point to the fifth corner 362.

The fifth end surface 36 connects to a fifth drive surface 363, which extends parallel to the rotational axis L. The fifth drive surface 363 connects to the fifth corner 362 and does not intersect with the rotational axis L. The edge of the fifth drive surface 363 opposite to the fifth end surface 36 lies on the reference plane P.

The sixth end surface 37 connects to the sixth peripheral surface 315, which is positioned between the first peripheral surface 31 and the fifth peripheral surface 314. The sixth end surface 37 includes a sixth edge 371 and a sixth corner 372 not on the sixth edge 371. The sixth edge 371 lies on the reference plane P, with one end proximate to the rotational axis L but not lying on the rotational axis L and the opposite end connecting to the sixth peripheral surface 315. The sixth corner 372 is positioned between the reference plane P and the body portion 20. The sixth peripheral surface 315 includes a recessed sixth anti-slip groove 395, with one end connecting to the sixth end surface 37 and the other end extending toward the body portion 20.

The distance from the connection point of the sixth anti-slip groove 395 with the sixth end surface 37 to the sixth edge 371 is greater than the distance from the connection point to the sixth corner 372.

The sixth end surface 37 connects to a sixth drive surface 373, which extends parallel to the rotational axis L. The sixth drive surface 373 connects to the sixth corner 372 and does not intersect with the rotational axis L. The edge of the sixth drive surface 373 opposite to the sixth end surface 37 lies on the reference plane P.

Each end surface 32, 33, 34, 35, 36, and 37 connects to a corresponding drive surface 323, 333, 343, 353, 363, and 373, which extends parallel to the rotational axis L and connects to the respective corner 322, 332, 342, 352, 362, and 372. These drive surfaces 23, 333, 343, 353, 363, and 373 do not intersect with the rotational axis L, and their edges opposite to the end surfaces lie on the reference plane P. The end surfaces are sequentially arranged, each positioned on the side opposite its predecessor's drive surface, without direct connection.

Each peripheral surface 31, 311, 312, 313, 314, and 315 includes a recessed anti-slip groove 39, 391, 392, 393, 394, and 395 that connects to its respective end surface 32, 33, 34, 35, 36, and 37 and extends toward the body portion 20. For each anti-slip groove 39, 391, 392, 393, 394, and 395, the distance from the connection point to the corresponding edge 321, 331, 341, 351, 361, and 371 is greater than to the corresponding corner 322, 332, 342, 352, 362, and 372.

The first through sixth anti-slip grooves 39, 391, 392, 393, 394, and 395 each extend parallel to the rotational axis L.

The drive portion 30 includes a seventh end surface 38 at its end opposite to the body portion 20. The seventh end surface 38 is a plane perpendicular to the rotational axis L and lies on the reference plane P. The seventh end surface 38 simultaneously connects to all the end surfaces 32, 33, 34, 35, 36, and 37, drive surfaces 323, 333, 343, 353, 363, and 373, and peripheral surfaces 31, 311, 312, 313, 314, and 315, creating a unified end face that helps guide the tool into engagement with a fastener.

For each of the first through sixth peripheral surfaces 31, 311, 312, 313, 314, and 315, the distance from the end proximate to the body portion 20 to the rotational axis L is less than the distance from the opposite end to the rotational axis L. This creates a tapered profile that improves the tool's ability to engage with damaged fasteners, complementing the anti-slip grooves' design.

The first through sixth end surfaces 32, 33, 34, 35, 36, and 37 are inclined planes that are not parallel to the reference plane P.

The drive tool 10 achieves excellent anti-slip performance through the structure described, enabling effective rotational of screws even when their drive holes are damaged. During use, the drive portion 30 can be inserted at an angle into damaged drive holes, with the corner formed by the first drive surface 323 and the first end surface 32 to contact the bottom of the drive hole, facilitating screw rotational. This works in conjunction with the first anti-slip groove 39, which allows the side wall of the drive hole to engage with the groove 39, further enhancing the anti-slip effect.

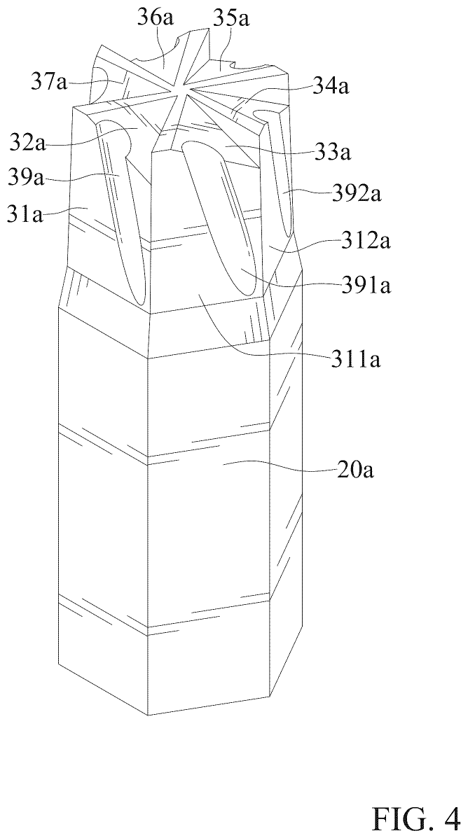

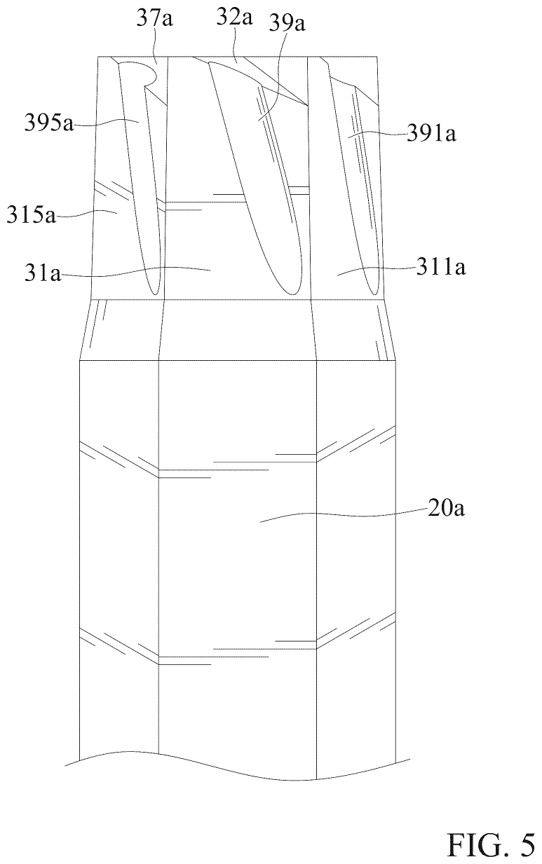

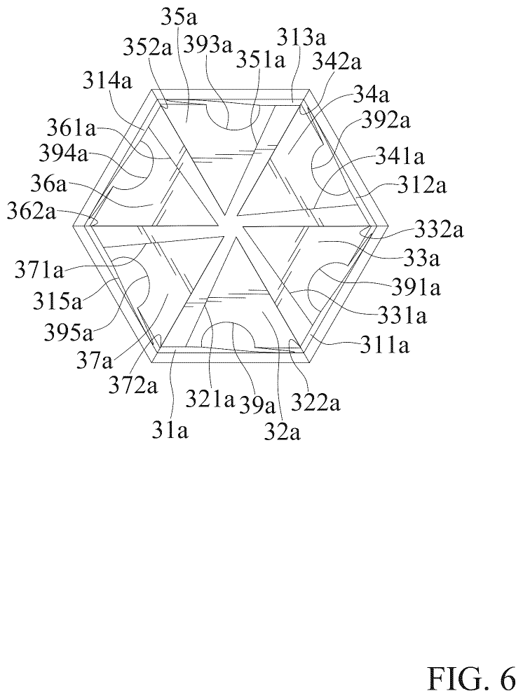

Referring to FIGS. 4-6, an anti-slip drive tool according to a second embodiment shares many characteristics with the first embodiment but introduces structural modifications. Components similar to those of the first embodiment are denoted with like reference numerals, suffixed with “a.” The second embodiment is generally similar to the first embodiment with the main difference being the relative distances of the anti-slip grooves from their respective edges and corners. In this embodiment, the distance from each anti-slip groove's 39a, 391a, 392a, 393a, 394a, and 395a connection point with its respective end surface 32a, 33a, 34a, 35a, 36a, and 37a to the corresponding edge 321a, 331a, 341a, 351a, 361a, and 371a is less than the distance to the corresponding corner 322a, 332a, 342a, 352a, 362a, and 372a, creating a different engagement pattern with damaged fasteners.

Additionally, in this second embodiment, the anti-slip grooves 39a, 391a, 392a, 393a, 394a, and 395a are positioned asymmetrically relative to their adjacent peripheral surfaces 31a, 311a, 312a, 313a, 314a, and 315a, with specific spacing relationships that enhance the tool's ability to grip damaged fasteners. For example, the distance from the first anti-slip groove 39a end near the body portion 20a to the second peripheral surface 311a is less than its distance to the sixth peripheral surface 315a, with similar relationships maintained for the other anti-slip grooves 391a, 392a, 393a, 394a, and 395a.

In view of the foregoing, the present invention offers the following advantages: The anti-slip drive tool includes a body portion and a drive portion formed at one end of the body portion, with the drive portion having a rotational axis and multiple peripheral surfaces with strategically positioned anti-slip grooves. This configuration enables effective engagement with damaged fasteners while preventing slippage during operation.

Although specific embodiments have been illustrated and described, numerous modifications and variations are still possible without departing from the scope of the invention. The scope of the invention is limited by the accompanying claims.

1. An anti-slip drive tool comprising:
a body portion and a drive portion formed at one end of the body portion, wherein the drive portion has a rotational axis and a first peripheral surface along the outer radial periphery of the drive portion relative to the rotational axis and a first end surface at the end of the drive portion opposite to the body portion connecting to the first peripheral surface, wherein the first end surface has a first edge and a first corner not on the first edge, wherein a reference plane is at the end opposite the body portion perpendicular to the rotational axis, wherein the first edge lies on reference plane with one end near the rotational axis and the opposite end connecting to first peripheral surface, wherein the first corner is positioned between reference plane and body portion, and wherein a first anti-slip groove configured to engage with damaged fasteners is recessed in the first peripheral surface with a first end of the first anti-slip groove connecting to first end surface and a second end extending toward body portion.

2. The anti-slip drive tool as claimed in claim 1, wherein the connection point of the first anti-slip groove to the first end surface does not connect to either the first edge or the first corner.

3. The anti-slip drive tool as claimed in claim 2, wherein the distance from the connection point of the first anti-slip groove to the first edge is greater than the distance from the connection point to the first corner.

4. The anti-slip drive tool as claimed in claim 3, wherein the first end surface connects to a first drive surface, wherein the first drive surface extends parallel to the rotational axis, wherein the first drive surface connects to the first corner, wherein the first drive surface does not intersect the rotational axis, and wherein the edge of first drive surface opposite to first end surface lies on reference plane.

5. The anti-slip drive tool as claimed in claim 4, further comprising a second peripheral surface adjacent to the first peripheral surface, a second end surface having a second edge on the reference plane, and a second corner not on the second edge, wherein one end of the first edge proximate to the rotational axis is not on the rotational axis, wherein the second edge with a first end proximate to the rotational axis not on the rotational axis and a second end connecting to second peripheral surface, wherein the second corner is between reference plane and body portion, wherein the second peripheral surface has a recessed second anti-slip groove with a first end connecting to second end surface and a second end extending toward body portion, and wherein the distance from the connection point of the anti-slip groove to the second edge is greater than the distance from the connection point to the second corner.

6. The anti-slip drive tool as claimed in claim 5, further comprising third, fourth, fifth, and sixth peripheral surfaces along the outer radial periphery of the drive portion and third, fourth, fifth, and sixth end surfaces connecting to their respective peripheral surfaces, wherein the third peripheral surface is adjacent to the second peripheral surface; wherein the fourth peripheral surface is adjacent to the third peripheral surface; wherein the fifth peripheral surface is adjacent to the fourth peripheral surface; wherein the sixth peripheral surface is positioned between the first and fifth peripheral surfaces; wherein each of the third through sixth end surfaces has a respective edge on the reference plane between the reference plane and the body portion; wherein each of the third through sixth peripheral surfaces has a respective anti-slip groove with a first end connecting to its respective end surface and a second end extending toward the body portion; wherein for each of the third through sixth anti-slip grooves, the distance from the connection point of the anti-slip groove to its respective edge is greater than the distance to from the connection point to its respective corner; wherein each end surface connects to a respective drive surface that extends parallel to the rotational axis; wherein each drive surface connects to its respective corner without intersecting the rotational axis; and wherein the edge of each drive surface opposite to its respective end surface lies on the reference plane.

7. The anti-slip drive tool as claimed in claim 6, wherein all anti-slip grooves extend parallel to rotational axis.

8. The anti-slip drive tool as claimed in claim 2, wherein the distance from the connection point of the first anti-slip groove to the first edge is less than the distance from the connection point to the first corner.

9. The anti-slip drive tool as claimed in claim 4, further comprising a second peripheral surface adjacent to the first peripheral surface, a second end surface having a second edge on the reference plane, and a second corner not on the second edge, wherein one end of the first edge proximate to the rotational axis is not on the rotational axis, wherein the second edge with a first end proximate to the rotational axis not on the rotational axis and a second end connecting to second peripheral surface, wherein the second corner is between reference plane and body portion, wherein the second peripheral surface has recessed second anti-slip groove with a first end connecting to second end surface and a second end extending toward body portion, and wherein the distance from the connection point of the anti-slip groove to the second edge is less than the distance from the connection point to the second corner.

10. The anti-slip drive tool as claimed in claim 9, further comprising third, fourth, fifth, and sixth peripheral surfaces along the outer radial periphery of the drive portion and third, fourth, fifth, and sixth end surfaces connecting to their respective peripheral surfaces, wherein the third peripheral surface is adjacent to the second peripheral surface; wherein the fourth peripheral surface is adjacent to the third peripheral surface; wherein the fifth peripheral surface is adjacent to the fourth peripheral surface; wherein the sixth peripheral surface is positioned between the first and fifth peripheral surfaces; wherein each of the third through sixth end surfaces has a respective edge on the reference plane between the reference plane and the body portion; wherein each of the third through sixth peripheral surfaces has a respective anti-slip groove with a first end connecting to its respective end surface and a second end extending toward the body portion; wherein for each of the third through sixth anti-slip grooves, the distance from the connection point of the anti-slip groove to its respective edge is less than the distance to from the connection point to its respective corner; wherein each end surface connects to a respective drive surface that extends parallel to the rotational axis; wherein each drive surface connects to its respective corner without intersecting the rotational axis; and wherein the edge of each drive surface opposite to its respective end surface lies on the reference plane.

11. The anti-slip drive tool as claimed in claim 5, wherein the end of the first anti-slip groove near body portion is closer to the second peripheral surface than to the sixth peripheral surface.

12. The anti-slip drive tool as claimed in claim 10, wherein the end of the first anti-slip groove near body portion is closer to the second peripheral surface than to the sixth peripheral surface.

13. The anti-slip drive tool as claimed in claim 11, wherein the end of the second groove near the body portion is closer to the third peripheral surface than to the first peripheral surface; the end of the third groove near the body portion is closer to the fourth peripheral surface than to the second peripheral surface; the end of the fourth groove near the body portion is closer to the fifth peripheral surface than to the third peripheral surface; the end of the fifth groove near the body portion is closer to the sixth peripheral surface than to the fourth peripheral surface; and wherein the end of the sixth groove near the body portion is closer to the first peripheral surface than to the fifth peripheral surface.

14. The anti-slip drive tool as claimed in claim 12, wherein the end of the second groove near the body portion is closer to the third peripheral surface than to the first peripheral surface; the end of the third groove near the body portion is closer to the fourth peripheral surface than to the second peripheral surface; the end of the fourth groove near the body portion is closer to the fifth peripheral surface than to the third peripheral surface; the end of the fifth groove near the body portion is closer to the sixth peripheral surface than to the fourth peripheral surface; and wherein the end of the sixth groove near the body portion is closer to the first peripheral surface than to the fifth peripheral surface.

15. The anti-slip drive tool as claimed in claim 6, further comprising a seventh end surface that is perpendicular to the rotational axis, wherein the seventh end surface lies on reference plane, and wherein the seventh end surface simultaneously connects to all end surfaces, drive surfaces, and peripheral surfaces.

16. The anti-slip drive tool as claimed in claim 10, further comprising a seventh end surface that is perpendicular to the rotational axis, wherein the seventh end surface lies on reference plane, and wherein the seventh end surface simultaneously connects to all end surfaces, drive surfaces, and peripheral surfaces.

17. The anti-slip drive tool as claimed in claim 6, wherein all six end surfaces are inclined planes not parallel to reference plane.

18. The anti-slip drive tool as claimed in claim 10, wherein all six end surfaces are inclined planes not parallel to reference plane.

19. The anti-slip drive tool as claimed in claim 6, wherein for all six peripheral surfaces, the distance from the end opposite body portion to the rotational axis is less than the distance from the end near body portion to the rotational axis, thereby creating a tapered profile.

20. The anti-slip drive tool as claimed in claim 10, wherein for all six peripheral surfaces, the distance from the end opposite body portion to the rotational axis is less than the distance from the end near body portion to the rotational axis, thereby creating a tapered profile.
